(19) United States
(12) Patent Application Publication
(10) Pub. No.: US 2018/0356509 A1
(43) Pub. Date: Dec. 13, 2018

(54) RADAR-BASED DETECTION SYSTEM

(71) Applicant: Uniqueradar Sweden AB, Hovas (SE)

(72) Inventor: Kasra HAGHIGHI, Hovas (SE)

(21) Appl. No.: 15/571,371

(22) PCT Filed: Sep. 1, 2016
(86) PCT No.: PCT/EP2016/070661

§ 371 Date: Nov. 2, 2017

(30) Foreign Application Priority Data
Sep. 3, 2015 (EP) 15183707.7

(51) Int. Cl. G01S 13/56; G01S 7/41; G01S 7/35; G01S 13/88; G08B 21/22

(52) U.S. Cl. CPC G01S 13/56; G01S 7/415; G08B 21/22; G01S 13/886; G01S 7/354

(57) ABSTRACT

The invention relates to a method of detecting at least one human-like and/or animal-like target in a detection zone by using a radar-based detection system comprising at least one FMCW radar, the method comprising:—generating radar signal and acquiring reflected radar signal at time ti,—applying signal processing on acquired reflected radar signal in order to improve SNR,—analysing the signal spectrum in order to detect distinguish features of target,—classifying distinguishing features of target in order to determine if target is relevant for further actions,—determining if a target deemed relevant for further actions is a false alarm,—applying further actions if target deemed relevant for further actions is not a false alarm. The invention further relates to a radar-based detection system for detection of targets using said method.

### TECHNICAL FIELD

The invention relates to a method of detecting at least one human-like and/or animal-like target in a detection zone by using a radar-based detection system comprising at least one frequency modulated continuous wave (FMCW) radar. The invention further relates to a radar-based detection system for detection of targets using said method.

### BACKGROUND ART

A number of detection methods for detecting a human-like target in a detection zone are known. Detection techniques vary from analysing video feeds to using various parts of the electromagnetic spectrum to identify a target. For instance LIDAR, IR sensing, Doppler radar, LF radar and FMCW radar can be used to detect human-like targets.

Known detection methods and systems only detect the presence or absence of a human-like target in a detection zone. Other characteristics of the human-like target cannot be detected in order to determine if further actions, such as triggering an alarm, are needed.

There is thus a need for an improved method and radar-based detection system.

### SUMMARY OF THE INVENTION

An object of this invention is to provide a method and a system for detecting at least one target in a detection zone wherein the above mentioned problems are avoided. In particular, it is an object of the invention to improve upon the known methods for detecting an object in a detection zone and to determine if a further action needs to be applied. This object is achieved by the method of claim 1 and the system of claim 9. With target is meant a human-like target or an animal-like target.

The invention relates to a method of detecting at least one human-like and/or animal-like target in a detection zone by using a radar-based detection system comprising at least one FMCW radar. The method comprises:
generating a radar signal and acquiring a reflected radar signal at time t1,
applying signal processing on the acquired reflected radar signal in order to improve signal-to-noise ratio (SNR),
analysing a signal spectrum in order to detect distinguishing features of target,
classifying distinguishing features of the target in order to determine if the target is relevant for further actions,
determining if a target deemed relevant for further actions is a false alarm,
applying further actions if target deemed relevant for further actions is not a false alarm.

The present invention monitors the detection zone by transmitting and receiving radar signals continuously into the detection zone. The signal is transmitted by at least one FMCW radar. The acquired signal goes through signal-processing, filtering and spectrum analysis to detect and extract distinguishing features of the target, such as speed or direction of the target within the detection zone. According to the detected and extracted distinguishing features, the existence of a target and the type of the target are recognized and its distinguishing features are classified. Depending on how the distinguishing features are classified, the target is determined to be either relevant or not relevant for further actions. Furthermore, the method evaluates false alarm signals and eliminates these. One aim of the invention is to identify whether it is relevant to take further action or not for a specific detected target. The mere detection of a target will not immediately cause the system to take further action, until the system has determined that the target is in danger or generally of interest for a specific application. Thus, a detected target will cause an application of a further action, e.g. raising an alarm, if and only if, it is a target in danger or of interest for the specific application of the method. In addition to this a check to verify that a target that seems to be in danger or of interest to the application is not a false alarm before applying the further action. The method can thus be used for recognizing a particular target behaviour or a target pattern causing a further action, such as raising an alarm, to be applied.

In case the method determines that the target is not a false alarm, any further action connected to the distinguishing feature of the target is applied. In previously known setups, a signal detects a target, e.g. a human-like target, or a non-target, e.g. an animal-like target, or absence of a target. If a non-target is detected as a target it is a false-alarm and if a target is missed, it is a misdetection.

One advantage of the invention is that the method uses a combination of:
firstly, signal processing in order to improve the SNR of the acquired reflected radar signal;
secondly, analysis of the signal spectrum in order to detect distinguish features of target; and
thirdly, analyse and classify the motion behaviour of the target in order to determine if the target is relevant for further actions and to avoid false-alarms.
   These features combined enable the method to improve the detection method.

The method can for instance in a first example be used at a pool area where targets relevant for further action are human-like targets, i.e. people in risk of drowning can be identified by classifying distinguishing features of the target. If the target is classified as being in danger of drowning, an alarm can be sent out to an electronic device held by the pool owner or supervisor, an audible alarm can be sent out at the pool or a flotation device can be released into the pool to assist the drowning victim. Targets relevant for further actions may of course also be animal-like targets such as cats or dogs.

The method may also comprise:
initializing and calibrating the FMCW radar,
processing the environment in the detection zone in order to set up parameters for calibration. With processing the environment is meant processing the data that the radar system records from the environment the system is set to monitor when there is no target in the detection zone. This processing can be used for e.g. eliminating DC level of the received signal or setting antenna parameters which will give maximum signal reflection. Parameters can also for instance be threshold levels and filtering parameters used to calibrate the method in order to remove false alarm signals and false positives. Processing the environment leads to a lower probability for false alarms.

The distinguishing features of the at least one target may be one or more of:
presence of the at least one target in the detection zone,
appearance of the at least one target in the detection zone,
disappearance of the at least one target from the detection zone,
speed of the at least one target within the detection zone,
direction of the at least one target within the detection zone,
altitude of the at least one target within the detection zone,
the at least one target entering or exiting the detection zone,
the at least one target entering the detection zone from an unexpected position.

By classifying one or more of the above listed distinguishing features, the method can determine if the target is relevant for further actions. Continuing with the first example of the swimming pool, if a target suddenly disappears from the detection zone without exiting the detection zone, it is highly likely that the target has entered the pool. If the target does not reappear within a certain predetermined period of time, the method determines that the target is in danger of drowning and initializes further actions. Further actions can be an alarm sent out to an electronic device held by the pool owner or supervisor, an audible alarm sent out at the pool or a flotation device released into the pool to assist the drowning victim. The distinguishing features can also be used to improve the determining if a target is human-like or not. For instance a possible target entering the detection zone from above, without first entering the detection zone is most likely a bird and can be disregarded by the method. After a certain time of day, presence of a target in the detection zone can indicate unwanted intrusion and can trigger a further action such as an alarm.

For identifying human movement, the extent of legs movement can be identified by the signal spectrum analysis. Artificial intelligence (Al) techniques, such as neural networks (NN), can be trained for behaviour identification using an inverse problem method. To use AI, a neural network can be trained offline and the applicable scenario can be uploaded to each unit deployed in the field. The trained NN software can be different for different choice of the customers. For a swimming pool, it can alert for entrance, staying or drowning of animals as well.

The method may also comprise:
tracking, analysing and predicting the behaviour of the at least one target at time t2, where t2 is later than t1. If the target leaves the detection zone, the method can track, analyse and, where necessary, predict the behaviour of the target in order to re-capture the target if it re-enters the detection zone. These features can also be used to determine that a predicted behaviour is not classified as a distinguishing feature and thereby a cause for initiation of further actions. When using multiple FMCW radar antennas or systems to cover a larger area, for instance a pool complex, a human-like target may move between detection zones of the multiple FMCW radar antennas or systems. The method can thus predict the behaviour of the target in order for the method to identify a target entering a second detection zone which does not overlap the first detection zone so that the target is not identified as a new target. These features can also be used to track targets when two or more targets cross paths in a detection zone, where one target obscures the second target from the radar's view.

The method may also comprise:
applying signal processing on the acquired reflected radar signal such as filtering and/or one of: a least square method, truncation of record length or reduction of zero mean, sample accumulation and staggered methods in order to improve SNR. The method can use a variety of methods to increase the quality of the acquired signal.

The method may further comprise:
using super resolution spectral estimation such as MUSIC or ESPRIT to analyse the signal spectrum in order to detect distinguish features of target,
using change detection method to classify distinguishing features of target in order to determine if target is relevant for further actions. Change detection methods may be one or more of sequential detection and Page change detection algorithm. The analysis of the signal spectrum in combination with the change detection methods can be used to analyse target motion to identifying if the target is human, animal, or even distressed human. One such method is analysing the micro-Doppler signature of the target.

The method may further comprise:
using a CFAR algorithm to determine if a target deemed relevant is actually a false alarm.

The further actions employed by the method may be one or more of:
sending an alarm message by means of one or more of: direct data transfer, SMS or email to a receiver,
sounding an alarm within the detection zone,
deploying a floating device for aiding a human in risk of drowning in a pool.

The invention further relates to a radar-based detection system for detection of human-like and/or animal-like targets using the above described method. The system comprises:
a RF front end comprising at least one FMCW radar,
an electronics module,
a data processing unit (2) including a DA/AD unit, and
a communication and alarm module.

The radar-based detection system is arranged to analyse a signal spectrum of an acquired reflected radar signal in order to detect distinguishing features of the target and to classify distinguishing features of the target in order to determine if the target is relevant for further actions according to the method described above.

The advantages of the system are the same as for the method.

The invention further relates to a computer program comprising program code means for performing the steps of the above described method, when the computer program is run on a computer device. The invention also relates to a computer readable medium carrying a computer program comprising program code means for performing the steps of the above described method when the computer program is run on a computer device.

Using a radar technology provides advantages over other types of sensing devices such as LIDAR and sonar systems, for instance in the first example of reducing the risk of drowning when the method and system is used at a swimming pool. Some of these advantages are that:
a radar system is more robust and less sensitive in different kinds of environmental conditions that causes water disturbance such as wind and rain and therefore less affected. The system performance is not degraded due to sun, snow or fog.
The system can be deployed without a need to be worn on persons or mounted inside the pool, in other words it is a completely non-contact system. This also enables the alarm system to be invisible or hidden, reducing the tamper risk.
The system is scalable and can be adjusted simply for different sizes of the detection area. This makes the system and method easily designable for different shapes of the pool.
Radar has a longer range of detection among other types of sensors.
The system can be operated without any human interaction or supervision unlike camera-based alarm systems.
Communication between and from the system is wireless and therefore it is possible to monitor the area remotely.
The system is installed easily since it is wireless and is capable of being battery operated. This means that no cabling is required. Moreover, since it does not have any glass window openings, it can be easily installed on walls, poles, trees, etc. It is also possible for the system to be connected to an uninterrupted power supply or to a continuous power source.

The system described herein differs from current FMCW systems in that the system:
analyses the signal spectrum in order to detect distinguish features of target,
classifies distinguishing features of the target in order to determine if the target is relevant for further actions,
determines if a target relevant for further actions is a false alarm,
applies further actions if target relevant for further action is not a false alarm.

These differences result in the possibility to control and change the FMCW radar signal to better match the environment and potential targets. Further the motion of different targets is tracked to find out targets relevant for further actions and to reject false alarms. Also, the received radar signal is analysed and it is possible to create a spectrum evolution over time, in order to create a profile of target. The system and method focuses on sequences of behaviours of a specific target, which makes it a relevant target. Any other target is rejected. A specific target can be a human-like target and/or an animal-like target depending on the application.

The system further has several benefits such as:
A low false alarm rate due to identifying different kinds of targets:
   human vs. animal
   live vs. dead
   general things blown by the wind.
By looking at time evolution of a target's behaviour it is possible to classify the targets much more accurately.
The system also consumes low power compared to for instance cameras which needs illumination, pan, tilt, heating, and extended processing.

### BRIEF DESCRIPTION OF THE DRAWINGS

FIG. 1 schematically describes a block diagram of the hardware of the radar-based system according to the invention,

FIG. 2 shows a flow chart over the method according to the invention,

FIGS. 3a-3d schematically show an example application of the method and system of the invention.

### DETAILED DESCRIPTION

In the description of the invention given below reference is made to the following figures in which one embodiment is exemplified. The figures are to be seen as a way of illustrating the invention.

The purpose of current invention is to use the radio waves emitted by a frequency modulated continuous wave (FMCW) short-range radar to detect distinguishing features of a human-like and/or animal-like target, to classify distinguishing features of the target in order to determine if the target is relevant for further actions, to determine if a target deemed relevant for further actions is a false alarm and to apply further actions if a target deemed relevant for further actions is not a false alarm. Distinguishing features can for instance be presence, appearance, entering or exiting of a human-like target and/or animal-like target to a detection area.

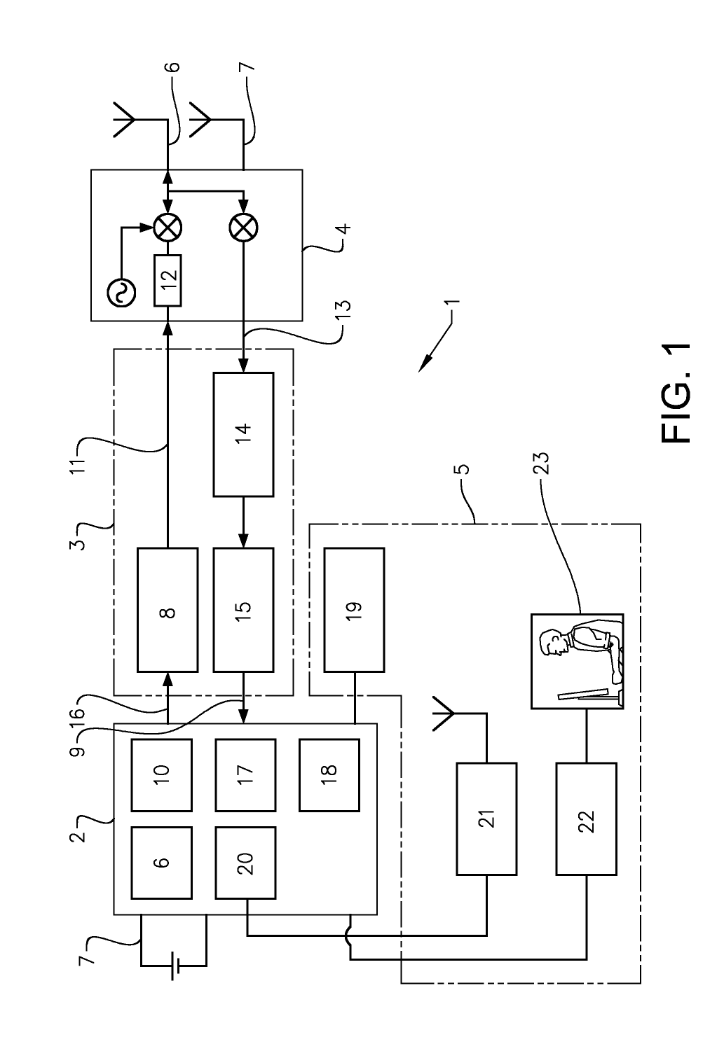

The schematic layout of a system 1 according to the invention is depicted in FIG. 1 as a hardware block diagram. The system 1 contains four major blocks:
Processing unit (Core) 2
Electronics module 3
RF Front End 4
Communication and alarm module 5

A system 1 comprises in its simplest form one processing unit 2, one electronics module 3, one RF front end 4 with at least two antennas 6, 7 and one communication and alarm module 5. When the system 1 is equipped with multiple RF front ends 4, multiple electronics modules 3 and processing units 2 are used. One communication and alarm block 4 is used per system 1. A system 1 may in one example comprise multiple antennas which are switched using one RF front end. Alternatively, multiple antennas with one front end per antenna or multiple antennas with individual RF front ends and processing units per antenna can be used.

The radar system 1 continuously emits periodic electromagnetic waves, which are sourced from frequency modulated (FM) sweeps created by the processing unit 2, electronics module 3 and RF front end (RF F/E) 4. A power management module 6 generates a transmission power provided by a battery 7 in the processing unit 2. Then, a radar control circuit 8 receives an analogue signal 9 from the digital-to-analogue converter (DAC) 10 and sends it to the RF F/E 4. The signal 11 to the RF F/E 4 is fed to a voltage controlled oscillator VCO 12 to produce radar sweeps with a predetermined output frequency and then these waves are radiated from the FMCW radar antennas 6, 7 to the environment. The radar system 1 comprises at least one computer readable medium, such as any kind of non-volatile memory, carrying a computer program comprising program code means for performing the steps of the method. The computer readable medium is preferably located on a processor chip. The steps are described in more detail below.

A reflected signal 13 from a target, being received by the RF F/E 4, is given to the electronics module 3 to be prepared for processing. The reflected signal 13 is given to the electronics module 3 for filtering in signal filtering 14 and amplification in signal amplifier 15. At this point the amplified signal 16 is converted to a digital signal through analogue-to-digital converter (ADC) 17. In the present example more than one RF F/E 4 is operating, with the additional RF F/E 4 not shown. A mesh unit 18 in the processing unit 2 receives the resulted detection from several units located around protection zone. Finally, an alarm signal is provided in a communication port 20 and will be available to be transferred via a wireless network 21 by communication module 5. Furthermore, an alarm signal such as a siren or a light 22 is sent to a system user 23 to inform him/her if something interesting has occurred.

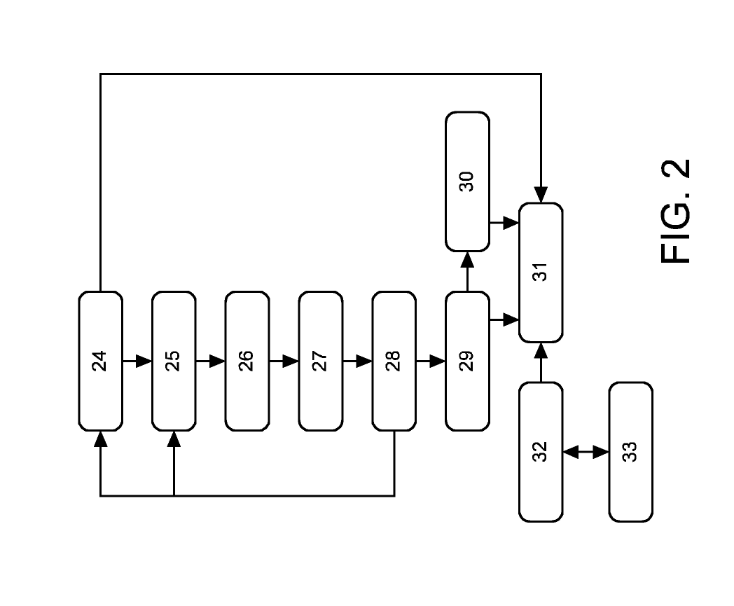

The software block diagram of the invention is illustrated in FIG. 2. In the first block 24, the system is calibrated and initialized and processes the environment in order to set up parameters. During calibration, the system will process the environment in the detection zone without a target. To process the environment, the system determines the position of, distances to and distances between all objects that are fixed in the environment in the detection zone. These fixed distances can be filtered out from the actual radar signal during its operation. Thereafter a sweep signal is generated by the radar control board and is transmitted by the FMCW antennas, see block 25. A reflected signal is acquired during signal acquisition in block 26. Block 27 contains the first level of signal processing which is pre-processing or signal conditioning. This includes low-pass filtering and other techniques to improve the signal to noise for further analysis; for example a least square method, truncation of record length or reduction of zero mean. After enhancing the signal, the signal time-frequency spectrum is analysed and, during operation, one or more distinguishing features are extracted in block 28. During calibration and initialization, information extracted from the time-frequency spectrum analysis performed in block 28 can be sent to block 24 to be used to evaluate the environment within the detection zone without targets in it, in block 24. Additionally, part of the information extracted in block 28 can be used to set signal parameters in order to generate a proper sweep signal in block 25.

During operation of the system, the method starts at step 25 and goes through steps 26, 27 and 28 as described above. In block 28, by using super resolution spectral estimation such as MUSIC or ESPRIT for analysing the signal spectrum, the distinguishing features of the target are detected, in order to detect the kind of target (human-like or otherwise). In block 28, by analyzing the time evolution of the signal spectrum, kinematic behavior of the target(s) is determined. This will result in distinguishing features unique to a certain type of movement. Further, the distinguishing features are classified in block 29 by use of change detection methods over an estimated signal. The other main signal processing technique is eliminating the clutter or rejecting the false alarm by use of some CFAR techniques, which is done in block 30. Moreover, the classified target is tracked and current information at a first time t1 is used to predict the behaviour of the target at a second time t2. In blocks 28 and 29, Al based deep neural network can be used for both feature extraction, behavior analysis and classification of targets based of behavior. Lastly, if a target is detected, an alarm message is sent out by the communication and alarm part in block 31. If something goes wrong in the self-test and initialization of the system in block 24 an alarm can be sent block 31 to inform that the detection zone is unprotected.

In addition the system is able to be recovered or to receive maintenance in case of a fault or malfunctioning. This is addressed in block 32. The power management of the system is handled in block 33. Failure in the power block 33 or battery can be handled by the maintenance unit 32.

The system is capable of performing in different operation modes:
1. System Power-up
2. Normal Operation
3. Malfunctioning and Error handling

During power-up, the system firstly performs a self-check for the different parts of the system to see if they are in a satisfactory status to be executed, for instance if the battery level is sufficient. A check to see if the communication to the control centre and each radar system are functioning correctly is also performed. This operation includes system calibration and setting up offset values. The offset values are calculated through calibration process. The operations by sending acknowledges of each check to the control centre to confirm the progress is well known. After all system checks are approved, the system is ready to be operational and starts the normal operations. As described above, malfunctioning and error handling are handled in a separate block and is readily activated if needed.

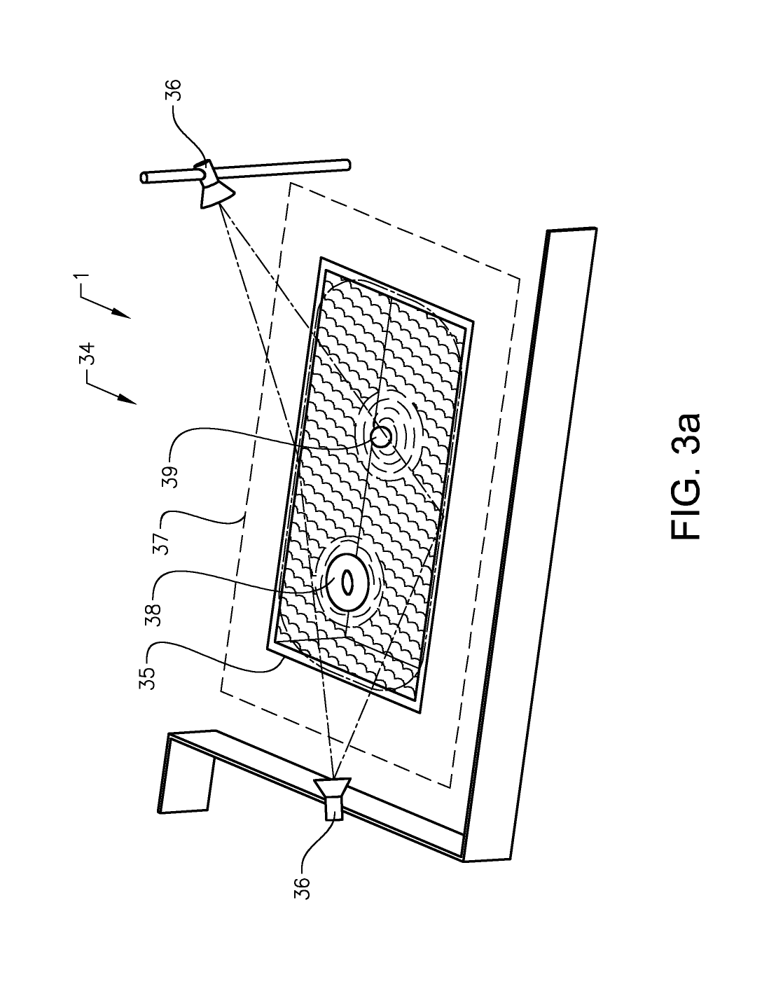

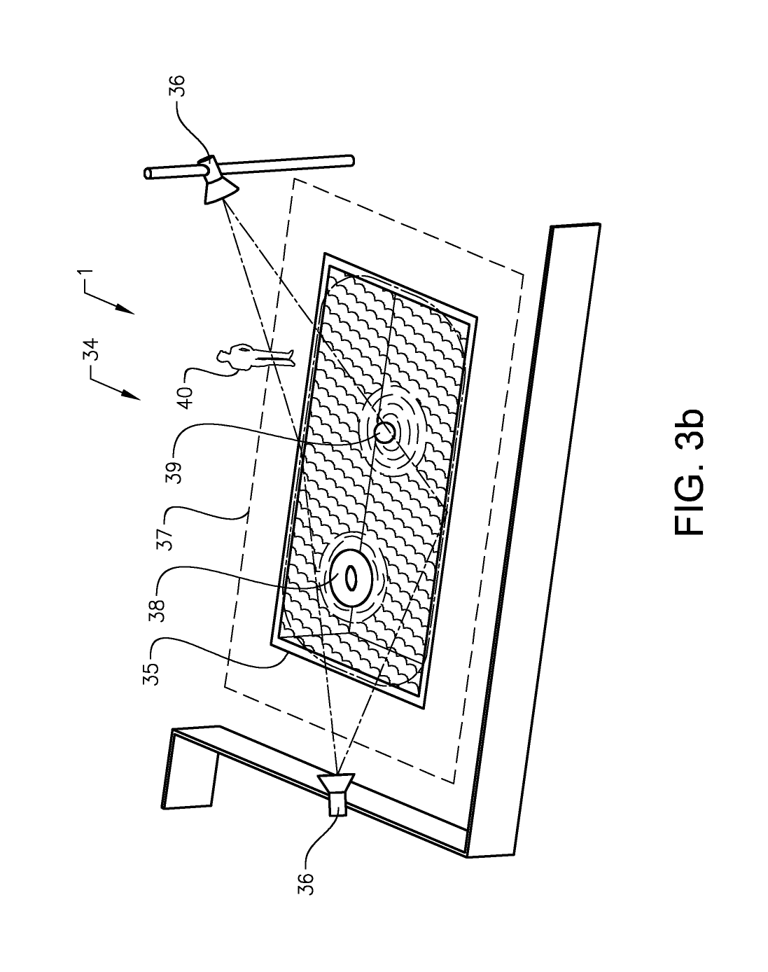

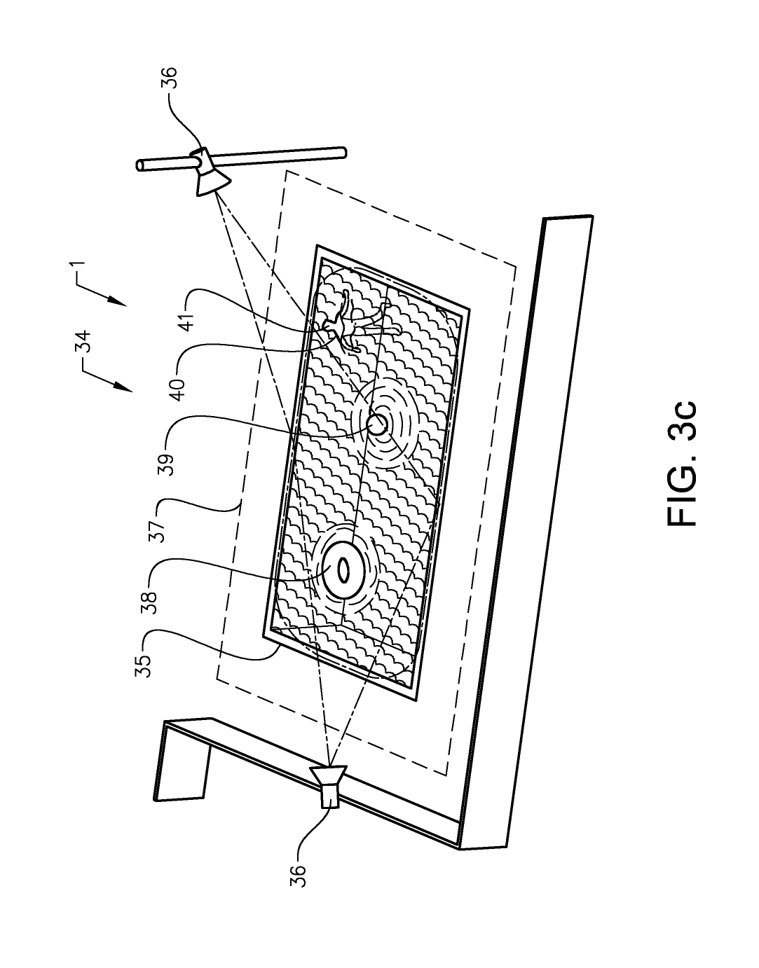

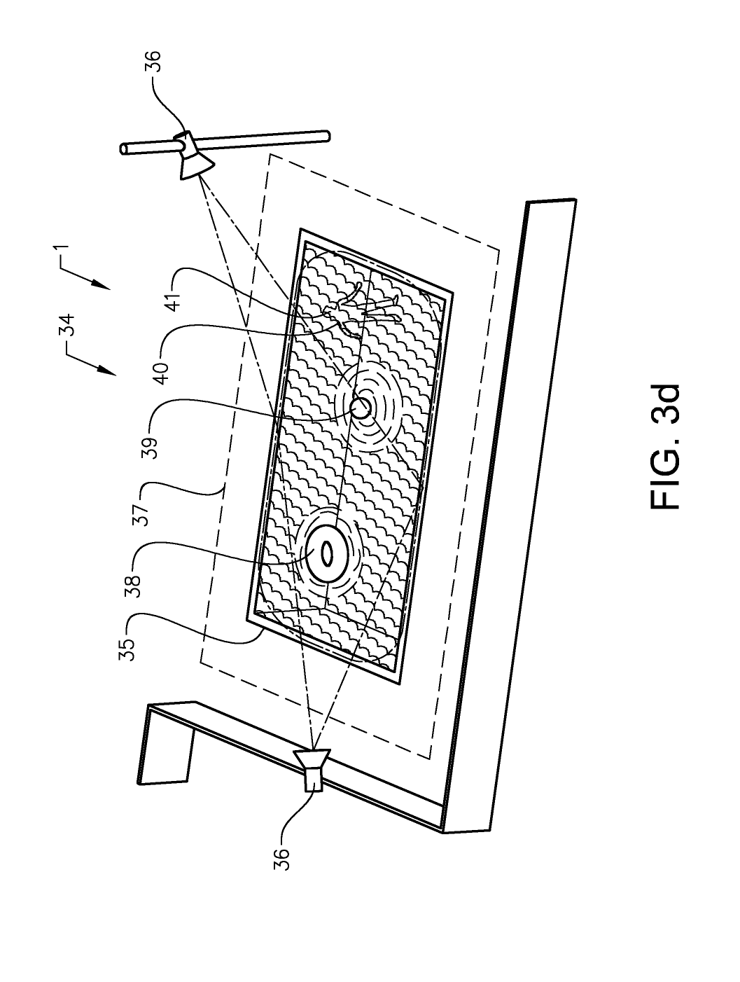

FIGS. 3a-3d schematically show an example application of the method and system 1 of the invention. The application is drowning prevention at a pool area 34 with pool 35. The pool 35 can either be a supervised public pool or a non-supervised private pool. In the case of the non-supervised private pool, the system 1 can be used both for drowning prevention and for possible intrusion detection.

FIG. 3a schematically show a pool area 34 with a pool 35 and two FMCW radar sensors 36 constituting one radar detection system 1. The two radar sensors 36 create a detection zone 37, which is the area under monitoring. The radar sensors 36 can be located at different places in the pool area 34 in order to set up a detection zone 37 that provides a good coverage of the pool area 34. For example the radar sensors 36 can be hanged over the pool or somewhere at the corner of the pool to provide a maximum detection range. In FIG. 3a the pool area 34 is empty and only a floating device 38 and a ball 39 is present in the pool 35. The system 1 is, by detecting and classifying distinguishing features of each target, able to see that both targets 38, 39 are not human-like targets and therefore no further actions need to be applied. Additionally, a target entering the detection zone 37 from above or which travels through the detection zone 37 at a certain height above ground are deemed not to be targets relevant for further actions as they are with a very high probability birds or large leafs.

In FIG. 3b a human-like target 40 has entered the detection zone 37. The system 1 detects that the target 40 is human-like and has classified the distinguishing feature of entering the detection zone 37. The system 1 tracks the target 40 as it moves within the detection zone 37 in order to classify further distinguishing features of the target 40 such as speed and direction. As an example, as long as the target 40 moves with a constant speed within the detection zone 37, the target 40 is not deemed relevant for further actions, as this is characteristic for walking.

In FIG. 3c the human-like target 40 has entered the pool and the head 41 of the human-like target 40 is visible. The human-like target's 40 head 41 is seen by the radar detection system 1 and is tracked in order to classify distinguishing features such as presence within the detection zone 37, speed and direction within the pool 35.

In FIG. 3d, the human-like target's 40 head 41 has disappeared beneath the surface of the pool 35. The radar detection system 1, tracking the distinguishing feature of presence within the detection zone 37, now classifies the distinguishing feature of disappearance of the target 40 without crossing the border of the detection zone 37. If the target's 40 head 41 disappears for a predetermined period of time, the system 1 recognizes that the target 40 is in risk of drowning and applies a further action by raising an alarm; by sending an alarm message by SMS or email to the pool owner and/or by raising an audible alarm within the pool area 34. Another action can be to deploy a floatation device, such as the floating device 38 in order for the human-like target 40 to be able to be saved, either by grabbing the floatation device himself or that by another person responding to the alarm enters the pool 35 to save the target 40.

Reference signs mentioned in the claims should not be seen as limiting the extent of the matter protected by the claims, and their sole function is to make claims easier to understand.

As will be realised, the invention is capable of modification in various obvious respects, all without departing from the scope of the appended claims. Further useful applications where detection of human-like target or animal-like targets is relevant are conceivable within the scope of the invention. Accordingly, the drawings and the description are to be regarded as illustrative in nature, and not restrictive.

1. A method of detecting at least one human-like and/or animal-like target in a detection zone by using a radar-based detection system comprising at least one FMCW radar, the method comprising:
generating radar signal and acquiring reflected radar signal at time tl,
applying signal processing on acquired reflected radar signal in order to improve SNR to obtain a signal processed radar signal,
analysing a signal spectrum of the signal processed radar signal in order to detect distinguishing features of the target,
classifying distinguishing features of the target in order to determine if the target is relevant for further actions,
determining if a target relevant for further actions is a false alarm,
applying further actions if target deemed relevant for further actions is not a false alarm.

2. A method according to claim 1, wherein the method comprises:
initializing and calibrating the FMCW radar
processing the environment in the detection zone in order to set up parameters for calibration.

3. A method according to claim 1, wherein the distinguishing features of the at least one target are one or more of:
presence of the at least one target in the detection zone,
appearance of the at least one target in the detection zone,
disappearance of the at least one target from the detection zone,
speed of the at least one target within the detection zone,
direction of the at least one target within the detection zone
altitude of the at least one target within the detection zone,
the at least one target entering or exiting the detection zone,
the at least one target entering the detection zone from an unexpected position.

4. A method according to claim 1, wherein the method comprises:
tracking, analysing and predicting the behaviour of the at least one target at time t2, where t2 is later than tl.

5. A method according to claim 1, wherein the method comprises:
applying signal processing on acquired reflected radar signal such as filtering and/or one of: a least square method, truncation of record length or reduction of zero mean, sample accumulation and staggered methods in order to improve SNR.

6. A method according to claim 1, wherein the method comprises:
using super resolution spectral estimation such as MUSIC or ESPRIT to analyse the signal spectrum in order to detect distinguish features of target,
using change detection method to classify distinguishing features of target in order to determine if target is relevant for further actions.

7. A method according to claim 1, wherein the method comprises:
using a CFAR algorithm to determine if a target deemed relevant for further actions is a false alarm.

8. A method according to claim 1, wherein the further actions are one or more of:
sending an alarm message by means of one or more of: direct data transfer, SMS or email to a receiver,
sounding an alarm within the detection zone,

9. Radar-based detection system for detection of human-like and/or animal-like targets using the method of claim 1, the system comprising:
a RF front end comprising at least one FMCW radar
an electronics module
a data processing unit including a DA/AD unit
a communication and alarm module.

10. (canceled)

11. A computer readable medium carrying a computer program comprising program code for performing the steps of claim 1 when the computer program is run on a computer device.
